(19) United States
(12) Patent Application Publication
(10) Pub. No.: US 2017/0247771 A1
(43) Pub. Date: Aug. 31, 2017

(54) APPARATUS AND METHOD FOR RECOVERY OF SOLID PARTICULATE MATERIAL

(71) Applicant: Xeros LTD, Rotherham, South Yorkshire (GB)

(72) Inventor: Iain Alexander SCOTT, Rotherham (GB)

(21) Appl. No.: 15/518,047

(22) PCT Filed: Oct. 8, 2015
(86) PCT No.: PCT/GB2015/052948

§ 371 Date: Apr. 10, 2017

(30) Foreign Application Priority Data
Oct. 10, 2014 (GB) 1418005.3

(51) Int. Cl. C14B 1/00; C14C 15/00; B08B 1/04; B08B 3/08; B08B 5/02; B08B 1/00

(52) U.S. Cl. CPC C14B 1/00; B08B 5/02; B08B 1/002; B08B 1/04; B08B 3/08; C14C 15/00

(57) ABSTRACT

Apparatus for recovery of a solid particulate material from an animal skin substrate subjected to a treatment using said particulate material, comprises a support arranged to support the animal skin substrate, at least one air knife arranged to direct its output flow of air to the animal skin substrate when supported on the support, and a transport arrangement configured to move at least one of the air knife and the animal substrate relative to the other. A method of recovering solid particulate material from such an animal skin substrate is also disclosed.

This invention relates to a methods and apparatus for the treatment of animal skin substrates which apparatus and methods employ a solid particulate material (which can also be referred to as “a multiplicity of solid particles”). Particularly, the invention relates to an apparatus and method for separating solid particulate material from an animal skin substrate after a treatment procedure of the animal skin substrate employing such solid particulate material.

In preferred embodiments, the animal skin substrate can be hide, pelt or leather. The treatment of the animal skin substrate employing the solid particulate material can be a process step, or a plurality of process steps, in forming a leather substrate from the animal skin substrate. The treatment of the animal skin substrate employing the solid particulate material can be a process step, or a plurality of process steps, in the treatment of an unfinished leather to form a finished leather substrate. Exemplary treatments of the animal skin substrate can include beamhouse processes, tanning, re-tanning, fatliquoring dyeing and finishing.

### BACKGROUND

Current methods for treating or processing animal skin substrates can necessitate the use of vast quantities of water. For example, in treatment methods wherein the animal skin substrate comprises a hide, typically 30 kg of water is required per kg of hide. Large volumes of water can be needed in order to remove unwanted materials from the animal skin (such as those that are liable to decomposition) and also in subsequent steps of the process which involve chemical modification to confer certain properties on the substrate. Chemical modification of the substrate can be carried out for the purpose of, inter alia, preserving, waterproofing, colouring and/or providing any desired textural or aesthetic qualities. The various steps described above will generally be performed in the presence of a treatment formulation comprising one or more components.

Due to the large amounts of water relative to the weight of animal substrate, current treatment processes known in the art also require a proportionate quantity of chemicals used in the treatment formulation to ensure an effective treatment of the substrate within an acceptable timeframe. Consequently, large amounts of effluents are produced from such processes which require safe disposal. Furthermore, long process times can be necessary. Such long process times can in particular be of benefit where only a low level of mechanical action is possible, in order to avoid damaging the animal skin substrate, for example.

Many of the methods for preparing animal skin substrates for human use (e.g. leather for clothing, shoes, upholstery etc) still remain predominantly based on traditional processes and there have been few advances in recent years. For example, methods for the processing and manufacturing of leather have remained largely unchanged for 75 years. EP0439108 filed in 1991 and directed to a process using carbon dioxide for deliming of hides, discloses an example of one of the few recent developments in this field.

Prior to the innovations disclosed herein, the applicant has previously addressed the problem of reducing water consumption in a domestic or industrial cleaning method, primarily in the field of laundry. In WO-A-2007/128962 there is disclosed a method and formulation for cleaning a soiled substrate, the method comprising the treatment of the moistened substrate with a formulation comprising a multiplicity of polymeric particles, wherein the formulation is free of organic solvents. The soiled substrate may be wetted so as to achieve a substrate to water ratio of between 1:0.1 to 1:5 w/w, and optionally, the formulation may additionally comprise at least one cleaning material, which typically comprises a surfactant, which most preferably has detergent properties. The soiled substrate may comprise a textile fibre. The polymeric particles may, for example, comprise particles of polyamides, polyesters, polyalkenes, polyurethanes or their copolymers, a particular example being nylon beads.

In WO2011/098815, the present applicant provided an apparatus for use in the cleaning of soiled substrates, primarily laundry, the apparatus comprising housing means having a first upper chamber with a rotatably mounted cylindrical cage mounted therein and a second lower chamber located beneath the cylindrical cage, and additionally comprising at least one recirculation means, access means, pumping means and a multiplicity of delivery means, wherein the rotatably mounted cylindrical cage comprises a drum having perforated side walls where up to 60% of the surface area of the side walls comprises perforations comprising holes having a diameter of no greater than 25.0 mm.

The applicant has observed that improvements in treatment processes for animal skin substrates, such as for the manufacture or dyeing of leather, can be achieved through including solid particulate material in the treatment environment with the animal skin substrate and required treatment chemicals. For example, the required quantity of treatment chemicals needed to process a given quantity of animal skin substrate can be reduced, as can treatment times and temperatures.

However, the problem of how efficiently and effectively to separate the solid particulate material from the treated animal skin substrate remains, and it is to this problem that embodiments of the invention are in particular directed.

### BRIEF SUMMARY OF THE DISCLOSURE

Thus, in broad terms, the present invention seeks to provide an apparatus and method for the recovery of solid particulate material from an animal skin substrate, after the animal skin substrate has been subjected to a treatment process employing the solid particulate material. The apparatus and method according to the present invention employ one or more air knives to displace the solid particulate material from the animal skin substrate. Preferably, a collecting device or arrangement can be provided to collect the solid particulate material displaced from the animal skin substrate.

The collected solid particulate material can be re-used in subsequent treatment processes of animal skin substrates. Preferably, the solid particulate material is re-used at least two, three, four, five or more times, such as 10, 20, 50 or 100 or more times, for treatment of animal skin substrates. The solid particles are typically not re-used more than 10,000 or more than 1,000 times.

In accordance with a first aspect of the present invention there is provided an apparatus for recovery of a solid particulate material from an animal skin substrate subjected to a treatment using said particulate material, the apparatus comprising a support arranged to support the animal skin substrate, at least one air knife arranged to direct its output flow of air to the animal skin substrate when supported on the support, and a transport arrangement configured to move at least one of the air knife and the animal substrate relative to the other.

In some preferred embodiments of the first aspect of the invention, the animal skin substrate can be maintained stationary and the transport arrangement can be operable to move the, or each, air knife relative to the animal skin substrate.

In some preferred embodiments of the first aspect of the invention, the, or each, air knife can be maintained stationary and the transport arrangement can be operable to move the animal skin substrate relative to the, or each, air knife.

In some preferred arrangements of the first aspect of the invention the transport arrangement can be operable to move both the animal skin substrate and the, or each, air knife.

In preferred embodiments of the first aspect of the invention, the transport arrangement can be the support or a part or component thereof.

In preferred embodiments of the first aspect of the invention, the apparatus can comprise a first air knife arranged to direct its flow of air towards a first surface of the animal skin substrate and a second air knife arranged to direct its flow of air towards an opposed second surface of the animal skin substrate.

In some preferred embodiments of the first aspect of the invention, the support can support the animal skin substrate in a substantially horizontal attitude.

In some preferred embodiments of the first aspect of the invention, the support can support the animal skin substrate in a substantially vertical attitude.

In some preferred embodiments of the first aspect of the invention, the support can support the animal skin substrate in an inclined attitude.

In the first aspect of the invention, the apparatus preferably further comprises a collecting device arranged to collect the solid particulate material displaced from the animal skin substrate by the or each air knife.

Preferably, the or each air knife is arranged not more than about 50 cm from the animal skin substrate during relative movement thereof, in particular not more than about 25 cm such as not more than about 10 mm or not more than about 5 mm. Generally the or each air knife should be arranged not less than 1 mm from the animal skin substrate during relative motion thereof. The above distances are measured as the shortest distance from the animal skin substrate to the part of the air outlet nearest to the animal skin substrate when the substrate is acted upon by a respective air knife. Depending on the orientation of the air knife relative to the substrate, the path length of the air output flow between the air outlet and the animal skin substrate can be longer than the above-mentioned lengths. Preferably, no part of the air knife should touch the animal skin substrate and preferably the nearest part of the air knife to the animal skin substrate should be spaced from the substrate by a distance not less than the particle diameter of the solid particulate material on the substrate.

In the first aspect of the invention, the support is preferably of substantially cylindrical shape and configured for rotation about its longitudinal axis thereby to move the animal skin substrate relative to the at least one air knife. The support can be a roller or substantially cylindrical brush. The roller can include a substantially rigid core or axle and a compliant, cushioning or deformable outer surface or surface layer, such as of a foam material or a rubber based material. Such a layer can deform to accommodate any residual particle of the solid particulate material which may be captured between the animal skin substrate and the roller. Damage to the animal skin substrate caused by such residual particle can thereby be avoided or mitigated. The bristles of the cylindrical brush can have the same effect. A drive device or apparatus to effect rotation of the support can be provided. A suitable drive device can be an electric motor.

In the first aspect of the invention, preferably the apparatus comprises first and second pairs of air knives arranged at respective sides of the cylindrical support, each air knife pair being arranged so that the air outlets thereof are substantially parallel to the longitudinal axis of the cylindrical support and the air output flow of each air knife of the pair being directed towards a plane extending between the air knives of the pair, the air knives being so positioned or positionable that a portion of the animal skin substrate extending substantially vertically downwardly from the support at a first side of the support can pass between the air knives of the first pair and a portion of the animal skin substrate extending substantially vertically downwardly from the support at a second side of the support can pass between the air knives of the second pair.

The particular locations of the air knives relative to the movement path of the animal skin substrate and relative to the support, and the particular output direction of the air flow of the air knives can be selected by the skilled person in order to achieve the most advantageous separation or displacement of the solid particulate material from the animal skin substrate and/or the most advantageous collection of the displaced solid particulate material.

In preferred arrangements the air output flow of each air knife can be directed downwardly.

In the first aspect of the invention, preferably the apparatus further comprises a collecting vessel configured to collect solid particulate material displaced from the animal skin substrate by the air knives, the vessel including an upwardly arranged wall member moveable between a first condition in which the plane extending between the first pair of air knives extends within a solid particulate material receiving portion of the vessel and a second condition in which said plane is external to a solid particulate material receiving portion of the vessel. Preferably said plane is a substantially vertical plane.

In the first aspect of the invention, preferably the particles of said solid particulate material have an average particle diameter of from about 1 mm to about 100 mm or from 1 to 50 mm or 1 to 25 mm or 1 to 15 mm or 1 to 10 mm, or 2 mm to 8 mm, or 0.5 to 6.0 mm. Advantageously, the particles of the solid particulate material have an average particle diameter of from about 4 mm to 8 mm, such as 5 mm to 7 mm. The effective average diameter can be calculated from the average volume of a particle by simply assuming the particle is a sphere. The average is preferably a number average. The average is preferably performed on at least 10, more preferably at least 100 particles and especially at least 1000 particles

In the first aspect of the invention, preferably the particles of said solid particulate material have a length of from about 1 mm to about 100 mm or from 1 to 50 mm or from 1 to 25 mm, or from 1 to 15 mm or from 1 to 10 mm, or 2 mm to 8 mm, or from 5 mm to 7 mm, or from 4 mm to 7 mm or from 1 mm to 6.0 mm, or from 1.0 to 5.0 mm or from 2.5 to 4.5 mm.

The length can be defined as the maximum two-dimensional length of each 3 dimensional solid particle. The average is preferably a number average. The average is preferably performed on at least 10, more preferably at least 100 particles and especially at least 1000 particles.

Preferably, the solid particles are spherical, spheroidal, or ellipsoidal. Other shapes are not, however, precluded.

In the first aspect of the invention, preferably said solid particulate material comprises a multiplicity of polymeric particles.

In the first aspect of the invention, preferably said solid particulate material comprises a multiplicity of non-polymeric particles.

In the first aspect of the invention, preferably said solid particulate material comprises a mixture of a multiplicity of polymeric and non-polymeric particles.

Preferably the polymeric or non-polymeric particles can comprise or be in the form of beads.

Preferably the polymer of the polymeric particles comprises polyalkenes, polyamides, polyesters, polysiloxanes, polyurethanes or copolymers thereof.

The polymer of the polymeric particles can comprise polyalkenes or polyurethanes, or copolymers thereof.

The polymer of the polymeric particles can comprise polyamide or polyester or copolymers thereof.

Said polyamide particles can comprise nylon. The polyamide particles can comprise Nylon 6 or Nylon 6,6.

The polyester particles can comprise polyethylene terephthalate or polybutylene terephthalate.

The solid particulate materials of the invention can be chemically modified to include additional moieties. Thus, the particles can be chemically modified to further include one or more moieties selected from the group consisting of: enzymes, oxidizing agents, catalysts, metals, reducing agents, chemical cross-linking agents and biocides.

The particles of the solid particulate material can comprise polyalkenes such as polyethylene and polypropylene, polyamides, polyesters, polysiloxanes or polyurethanes.

Furthermore, said polymers can be linear, branched or crosslinked. Said polymeric particles can comprise polyamide or polyester particles, particularly particles of nylon, polyethylene terephthalate or polybutylene terephthalate, typically in the form of beads. Copolymers of the above-polymeric materials can also be employed for the purposes of the invention. The properties of the polymeric materials can be tailored to specific requirements by the inclusion of monomeric units which confer particular properties on the copolymer. Various nylon homo- or co-polymers can be used including, but not limited to, Nylon 6 and Nylon 6,6. In an embodiment, the nylon comprises Nylon 6,6 copolymer, preferably having a molecular weight in the region of from 5000 to 30000 Daltons, more preferably from 10000 to 20000 Daltons, most preferably from 15000 to 16000 Daltons. The polyester can typically have a molecular weight corresponding to an intrinsic viscosity measurement in the range of from 0.3 to 1.5 dl/g, as measured by a solution technique such as ASTM D-4603. Said polymeric particles can comprise synthetic or natural rubber.

Preferably, the polymeric particles have an average density of about 0.5 g/cm³ to about 3.5 g/cm³ and preferably about 0.5 to 2.5 g/cm³. In other embodiments the polymeric particles have an average density of 0.5 to less than 1 g/cm³.

The solid particulate material can preferably be of such a size as to have an average mass in the region of 1 mg to 500 g, more preferably from 1 mg to 100 g, more preferably from 1 mg to 1 g and most preferably 5 mg to 100 mg.

Preferably the non-polymeric particles comprise particles of ceramic material, refractory material, igneous, sedimentary or metamorphic minerals, composites, metal, glass or wood.

Preferably, the non-polymeric particles have an average density of 0.5 to 20 g/cm³, more preferably from 2 to 20 g/cm³, especially from 4 to 15 g/cm³ and more especially from 4 to 10 g/cm³.

According to a second aspect of the present invention there is provided a method of recovering a solid particulate material from an animal skin substrate subjected to a treatment using said particulate material, the method comprising supporting the animal skin substrate on a support, directing an output flow of air from at least one air knife to the animal skin substrate and moving at least one of the air knife and the animal substrate relative to the other thereby to displace solid particulate material from the animal skin substrate.

In some preferred embodiments of the second aspect of the invention the method can comprise maintaining the animal skin substrate substantially stationary and moving the, or each, air knife relative to the animal skin substrate.

In some preferred embodiments of the second aspect of the invention the method can comprise maintaining the, or each, air knife substantially stationary and moving the animal skin substrate relative to the, or each, air knife.

In some preferred embodiments of the second aspect of the invention the method can comprise moving relative to one another (i) the animal skin substrate and (ii) a first air knife arranged to direct its flow of air towards a first surface of the animal skin substrate and a second air knife arranged to direct its flow of air towards an opposed second surface of the animal skin substrate.

In some preferred embodiments of the second aspect of the invention the method can comprise supporting the animal skin substrate in a substantially horizontal attitude.

In some preferred embodiments of the second aspect of the invention the method can comprise supporting the animal skin substrate in a substantially vertical attitude.

In some preferred embodiments of the second aspect of the invention the method can comprise supporting the animal skin substrate in an inclined attitude.

In the second aspect of the invention preferably the method further comprises collecting solid particulate material displaced from the animal skin substrate by the or each air knife with or in a collecting device.

In the second aspect of the invention preferably the method comprises mounting the animal skin substrate about a support of substantially cylindrical shape and rotating said support about its longitudinal axis thereby to move the animal skin substrate relative to the at least one air knife.

In the second aspect of the invention preferably the support is a roller or substantially cylindrical brush. The roller can have a complaint, cushioning or deformable surface.

In the second aspect of the invention preferably the method comprises rotating said support to pass a first portion of the animal skin substrate extending substantially vertically downwardly from the support at a first side of the support between a first pair of air knives arranged at the first side of the cylindrical support and rotating said support to pass a second portion of the animal skin substrate extending substantially vertically downwardly from the support at a second side of the support between a second pair of air knives arranged at the second side of the cylindrical support, the air flow of each air knife of the pair being directed towards a plane extending between the air knives of the pair.

Preferably said rotation to pass the first portion of the animal skin substrate between the first pair of air knives is in an opposite sense to said rotation to pass the second portion of the animal skin substrate between the second pair of air knives.

At least part of the first portion of the animal skin substrate can pass between the first pair of air knives and at least part of the second portion of the animal skin substrate can pass between the second pair of air knives during both said rotations.

In the second aspect of the invention preferably the air flow of each air knife is directed downwardly.

In the second aspect of the invention preferably the method further comprises: moving an upwardly arranged wall member of a collecting vessel between a first position in which the vessel is configured to collect solid particulate material being displaced from the first portion of the animal skin substrate by the air knifes, and a second position in which a substantially vertical plane extending between the air knives of the first pair is external to a solid particulate material receiving portion of the vessel; and rotating said support to move said first portion downwardly in said plane.

In the second aspect of the invention preferably the method comprises arranging the animal skin substrate on the support such that a first lower marginal portion of the animal skin substrate at a the first side of the support is disposed below the first pair of air knives, arranging a collecting vessel in a first position or configuration to collect solid particulate material displaced from said first portion of the animal skin substrate, rotating the support such that said first lower marginal portion moves upwardly and said first portion of the animal skin substrate passes between the air output flows of the first pair of air knives and said second portion of the animal skin substrate moves downwardly between the second pair of air knives, adjusting the collecting vessel to a second position or configuration, rotating the support such that said first lower marginal portion moves downwardly and said second portion of the animal skin substrate moves upwardly between the second pair of air knives, wherein (a) the second position or configuration of the collecting vessel is such that, by said downward movement of the first lower marginal portion, at least the first marginal portion of the animal skin substrate is positioned externally of the collecting vessel (b) the extent of rotation of the support is such that every part of the animal skin substrate is subjected to output air flows of the first or second pair of air knives. Some parts of the animal skin substrate can, at different times, be subjected to output air flows of the first and second pair of air knives.

In the second aspect of the invention preferably the recovered solid particulate material is re-used in at least one further treatment process or procedure for an animal substrate.

According to a third aspect of the present invention there is provided a method of treating an animal skin substrate comprising agitating said animal substrate in a vessel in the presence of solid particulate material and treatment chemicals, removing the animal substrate from the vessel and recovering said solid particulate material by a method according to the second aspect of the invention.

In the third aspect of the invention preferably the method comprises re-using the recovered solid particulate material in a further method according to the second aspect of the invention. Preferably the solid particulate material is re-used at least two, three, four, five or more times, such as 10, 20, 50 or 100 or more times, for treatment of animal skin substrates. The solid particles are typically not re-used more than 10,000 or more than 1,000 times.

In the third aspect of the invention preferably the vessel is a rotatably mounted drum and the agitation of the animal skin substrate can comprise rotating the drum.

Preferably said drum has a capacity of from 500 to 200,000 litres

Preferably the drum has a treatment volume or portion in which treatment of the animal skin substrate is effected. The treatment volume can have an ullage volume of at least 10% by volume, preferably at least 20% by volume, and more preferably from 30 to 70% or from 30 to 60% by volume. These ullage volumes can be effective in order to provide for efficient mixing whilst maximising the utilisation capacity of the apparatus. The drum can be constructed (for example in terms of its internal capacity) to achieve desired ullage volumes with a loading of animal skin substrate typical in the art.

The characteristics and parameters of the solid particulate material in the second and third aspects of the invention can be as defined in relation to the first aspect of the invention. Thus, broadly:—

in the second or third aspects of the invention preferably said solid particles have an average particle diameter of from about 1 mm to about 100 mm;

in the second or third aspects of the invention preferably said solid particles have a length of from about 1 mm to about 100 mm;

in the second or third aspects of the invention, preferably said solid particulate material comprises a multiplicity of polymeric particles;

in the second or third aspects of the invention, preferably said solid particulate material comprises a multiplicity of non-polymeric particles; and/or

in the second or third aspects of the invention, preferably said solid particulate material comprises a mixture of a multiplicity of polymeric and non-polymeric particle.

Preferably the or each animal skin substrate is a hide or pelt.

Preferably, the treatment to which the animal skin substrate is subject prior to the process of the second aspect of the invention, or, the treatment prior to removal of the solid particulate material according to the third aspect of the invention, is a tannery process.

Preferably said tannery process is selected from one or more of cleaning, curing, beamhouse treatments including soaking, liming, unhairing, scudding, deliming, bating, pickling and fat treatment liquoring, enzyme treatment, and dye fixing.

Preferably said treatment process is a process used in the production of leather.

Preferably said process used in the production of leather includes one or more of: curing, beam house operations, fatliquoring, scudding, soaking, liming, unhairing, fleshing, re-liming, bating, degreasing, bleaching, pickling, depickling, pretanning, tanning, retanning, tawing, crusting, colouring (dyeing) and finishing.

Preferably, the treatment process is carried out in the presence of a treatment liquor.

Preferably the treatment liquor is aqueous. The treatment liquor can comprise at least 5% w/w water, or between 5% and 99.9% w/w water. The treatment liquor can comprise not more than 99.9% w/w water.

Preferably said treatment liquor comprises at least one treatment agent selected from tanning agents, re-tanning agents and tannery process agents.

Preferably said treatment liquor comprises at least one colourant.

Preferably said colourant is selected from one or more dyes, pigments, optical brighteners or mixtures thereof.

### BRIEF DESCRIPTION OF THE DRAWINGS

Embodiments of the invention are further described hereinafter with reference to the accompanying drawings, in which:

FIG. 1 is a schematic illustration of an apparatus according to the invention.

### DETAILED DESCRIPTION

As noted above, the applicant has appreciated that improvements in treatment processes for animals skin substrates, such as for the manufacture or dyeing of leather, can be achieved through including solid particulate material in the treatment environment with the animal skin substrate and such treatment chemicals as may be required. In particular, improvements can be achieved by agitating the animal skin substrate in a vessel in the presence of appropriate treatment chemicals and the solid particulate material. The applicant has postulated that an enhanced, but still relatively gentle, mechanical action attributable to the presence of the solid particulate material can lead to the enhanced outcomes of the treatment processes. For example, the required quantity of treatment chemicals needed to process a given quantity of animal skin substrate can be reduced, as can treatment times and temperatures.

After such a treatment process the solid particulate material must be removed from the animal skin substrate. In this way, the animal skin substrate can be readied for such further treatments as may be necessary, or can be used directly in the manufacture of finished articles such a leather goods. Also, the recovered solid particulate material can then be re-used in a subsequent treatment process for the same or further substrates.

However, the applicant has further appreciated that effective removal of the solid particulate material from the substrate presents some challenges.

Notably, the treatment performed by the invention is distinguished from processes such as “laundering” wherein the substrate is typically a finished garment or fabric (being a manufactured article) and wherein the treatment merely relates to removing stains, soil and other unwanted matter from the surface of the substrate. Separation of solid particles from animal skin substrates can be complicated by the texture and composition of the substrate which typically comprises a soft, fleshy tissue. The soft, fleshy nature of such substrates can increase the likelihood that solid particles, when agitated with the substrate in a rotating drum, will adhere to the substrate surface or become embedded therein.

The applicant notes, for example, simply hanging the treated animal skin substrate in a vertical attitude with the intention that the sold particulate material will fall from the animal skin substrate is not effective, or at least in not effective within a commercially acceptable timescale. The applicant has appreciated that some physical action to remove the solid particulate material from the substrate is advantageous to achieve efficient and effective separation of the particulate material from the animal skin substrate. However, a mechanical action which includes contact of moving parts or components of a removal apparatus with the animal skin substrate is potentially problematic because of the need to avoid surface damage, or worse, to the substrate. Also, the nature of the animal skin substrate, as a natural product, can mean that it is irregular, making effective positioning and adjustment of devices relying on a mechanical action on the substrate potentially problematic, especially in a high throughput commercial environment.

In the light of these constraints, the applicant has appreciated that effective and efficient removal of solid particulate material from the animal skin substrate can be achieved by the use of one or more air knives to direct a flow of air at the animal skin substrate. The output flow of air from the air knife can displace solid particulate material from the animal skin substrate surface without damaging the animal skin substrate, and in particular without damaging or degrading the surface (or surface finish) of the animal skin substrate. Furthermore, by use of an air knife, separation of the solid particulate material from the animal skin substrate can be achieved rapidly, that is, within a time period suitable for commercial implementation, and to a high degree. For example, the degree of recovery of the solid particulate material from the animal skin substrate can be more than 90%, such as more than 95%, more than 99%, more than 99.9% or more than 99.99%. The percentage degree of recovery is preferably a wt %. Preferably, the percentage degree of recovery as mentioned herein relates only to the removal of the particulate material by the apparatus or method of the present invention.

Advantageously, the method of the invention can be carried out, or the apparatus of the invention can be used, after a preliminary processing or treatment of the animal skin substrate to remove a majority of the solid particulate material initial present on the substrate. This can result in especially good overall recovery of the solid particulate material so that substantially no solid particulate material, or indeed absolutely no solid particulate material, remains on the animal skin substrate.

The extent of separation of solid particulate material from the animal skin substrates can be determined by calculating the removal or separation efficiency. The removal or separation efficiency can preferably be calculated by the following steps:

i. recovering the solid particulate material following its use in the treatment process carried by the apparatus of the present invention or in the method(s) of the present invention;

ii. rinsing and drying the particulate solid materials recovered in step i); iii. recording the weight of recovered particulate solid material—A;

iv. recovering the particulate solid material which remains after step i);

v. rinsing and drying the particulate solid materials recovered in step iv);

vi. recording the weight of recovered particulate solid material—B;

vii. calculating the percentage efficiency by use of the equation:—

Separation Efficiency (wt %)=100×A/(A+B).

Step iv. can conveniently be performed by manually hand picking and shaking the remaining solid particulate material from the animal skin substrate.

The rinsing step can be useful for removing any animal skin substrate and treatment liquor residues from the particles. Preferably, this is done by water rinsing.

By way of example, if preliminarily processing or treatment provides a bead removal or separation efficiency of 95 wt % of the particulate material and then subsequently the method or apparatus of present invention further has a bead removal efficiency of 95 wt % of the remaining particulate material, the net total efficiency is 95%+99%×5 which is 99.95 wt %. Such stringent removal of the particulate material is especially desirable as just one particle of the solid particulate material remaining on the animal skin substrate can prevent a subsequent step, such as coating, colouring, fat-liquoring, re-tanning, sammying etc., from uniformly treating the animal skin substrate, potentially leading to unacceptable imperfections in the finished product.

Preferably, the animal skin substrate prepared using the apparatus or by the method of the present invention has on average less than 10 g of particulate material per 10 kg of animal skin substrate, more preferably less than 10 g per 100 kg of animal skin substrate and especially less than 10 g per 1000 kg of animal skin substrate. For this measurement the animal substrate weight can be a wet but is preferably a dry weight.

The animal skin substrate can be mounted to a support. At least one air knife is located proximate the support so that the output flow of the, or each, air knife is directed towards the animal skin substrate when mounted on the support. Relative movement is effected between the or each air knife and the support. In some preferred embodiments, the, or each, air knife is held stationary and the support is moved so that the animal skin substrate moves relative to the, or each, air knife. In other preferred embodiments, the animal skin substrate can be held stationary by the support and the, or each, air knife can be moved relative to the animal skin substrate. In some further preferred embodiments, both the animal skin substrate and the, or each, air knife can be moved at the same time.

In preferred arrangements, the support supports the animal skin substrate in a flat or smooth configuration. Here, “flat or smooth” is not intended to mean that the animal skin substrate is supported only in a generally planar configuration (although a planar configuration is not excluded). Rather, “flat or smooth” indicates an absence of folds, tucks, creases and the like and an absence of bumps or depressions, valleys, ridges and the like, noting that some lack of uniformity in the animal skin substrate may be unavoidable because of its natural origins.

In some arrangements the support can be a continuous uninterrupted planar structure. In other arrangements the support can be perforate or reticulate. In further arrangements the support can have a generally horizontally arranged upper surface on which the animal skin substrate can be arranged in its flat or smooth condition. In still further arrangements, the support can have an inclined upper surface on which the animal skin substrate can be arranged in its flat or smooth condition. In yet further preferred arrangements, the animal skin substrate, or at least one portion thereof, can be arranged to hang substantially vertically from the support.

In further particularly preferred embodiments, more than one air knife can be provided. More especially, at least one air knife can be provided at each opposed surface of the animal skin substrate. In this way, the solid particulate material can be displaced from each side of the animal skin substrate at the same time, rendering the removal process more efficient.

In further variations different air knives can be used to address different portions of the animal skin substrate. A plurality of air knives can be arranged linearly (so that their air output flow is substantially co-linear) such that an uninterrupted air flow can be provided across a full width of the animal skin substrate, for example.

In further preferred embodiments more than one air knife can be provided to address a given area or portion of the animal skin substrate. Such a given area or portion can be, a part of the animal skin substrate which can comprises a higher proportion of solid particulate materials relative to other parts of the animal substrate. This can, for example, include areas of the animal skin substrate where poor fleshing, splitting or flaying has occurred in prior treatment methods and which can thus preferentially retain solid particulate material. In preferred arrangements, each air knife can be positioned and/or aligned or oriented independently of the position or alignment of any other air knife.

In further preferred embodiments an imaging system can be provided. The imaging system can address the animal skin substrate and can be configured and/or calibrated to detect areas or regions of the animal skin substrate having solid particulate material thereon, areas or regions having higher amounts of the solid particulate material thereon. The imaging system can direct or configure one or more of the air knives—such as by cooperation with an apparatus controller which controls the operation of the air knives—such that the air flow output of the respective air knife or knives is (are) directed to said areas or regions to effect removal of the solid particulate material from such areas or regions.

In further embodiments a sensing arrangement or device can be provided to determine the position of the animal skin substrate, or more particularly to determine the edges or boundaries of the animal skin substrate. Being a natural product, there can be considerable variation in the size and shape of different animal skin substrates. The sensing arrangement can be a part or function of the above imaging system. In simpler arrangements, the sensing arrangement can include one or more light gates or limit switches, for example.

In preferred embodiments of the invention means, apparatus or a device can be provided for collecting the solid particulate material displaced from the animal skin substrate. The collected solid particulate material can be re-used in the treatment of further animal skin substrates. The process of treating an animal skin substrate, recovering the solid particulate material from the animal skin substrate and re-using the solid particulate material in the treatment of further animal skin substrates can be repeated multiple times with the same solid particulate material. The solid particulate material may be subjected to additional steps between treatment processes of the animal skin substrate. Such additional steps can be a cleaning of the solid particulate material, such a by rinsing in an appropriate medium. The cleaning can be effective to remove residues derived from the animal skin substrate, and/or to remove treatment chemicals used in the process of treatment of the animal substrate.

Conveniently, the means, apparatus or device for collecting the solid particulate material can be a vessel such as a tank, trough, vat or the like positioned to capture solid particulate material displaced from the animal skin substrate by the, or each, air knife. The vessel can be arranged below the animal skin substrate when said substrate is mounted on the support. In some preferred variations, the vessel can include side wall or walls (depending on its particular configuration) which extend upwardly from a base towards the height or level at which the animal skin substrate is supported by the support. Said side walls can extend upwardly beyond the height or level at which the animal skin substrate is supported. The construction of the vessel as such may not be critical provided that the vessel is effective in collecting solid particulate material displaced by the, or each, air knife from the animal skin substrate.

In preferred embodiments the animal skin substrate may be in a wet state, such as a result of prior processing steps. Such prior processing steps can include treatment of the animal skin substrate with one or more liquids such as treatment chemicals, water, rinsing agents and cleaning agents, residual amounts of which can remain on the animal skin substrate along with the solid particulate material. Accordingly, the means, apparatus or device for collecting the solid particulate material can usefully include a separator to separate the solid particulate material from such residual liquids after displacement thereof from the animal skin substrate by the air knife or air knives. The separator can conveniently take the form of a mesh, screen or the like arranged in the above-noted vessel, the mesh or screen including apertures sized to permit the passage of the residual liquid but to retain the solid particulate material.

In preferred arrangements, the animal skin substrate can be supported by the support in an inclined or in a substantially vertical orientation. Advantageously, the output flow of the, or each, air knife is directed downwardly. In this way, the solid material displaced from the animal skin substrate can be directed towards a colleting vessel arranged below the animal skin substrate.

Air knives as such are well known to the skilled person and need not be described in detail here. Generally, an air knife defines a narrow relatively longitudinally extensive slot through which air is expelled under pressure. The air output flow thus is substantially planar.

In preferred embodiments of the invention a suction apparatus, such as a vacuum suction apparatus can be provided. The suction apparatus can be applied to the animal skin substrate before or after the animal skin substrate is subjected to the action of the air knife or knives. In embodiments where the suction device is applied before the air knife or knives, the suction device can, for example, be configured to remove relatively larger amounts of solid particulate material from relatively larger areas of, or the whole of, the animal skin substrate. In embodiments where the suction device is applied after the air knife or knives, the suction device can, for example, be configured to address relatively local areas of the substrate where small residual amounts of solid particulate material might remain. The suction device can address a plurality of such relatively local areas simultaneously or in succession.

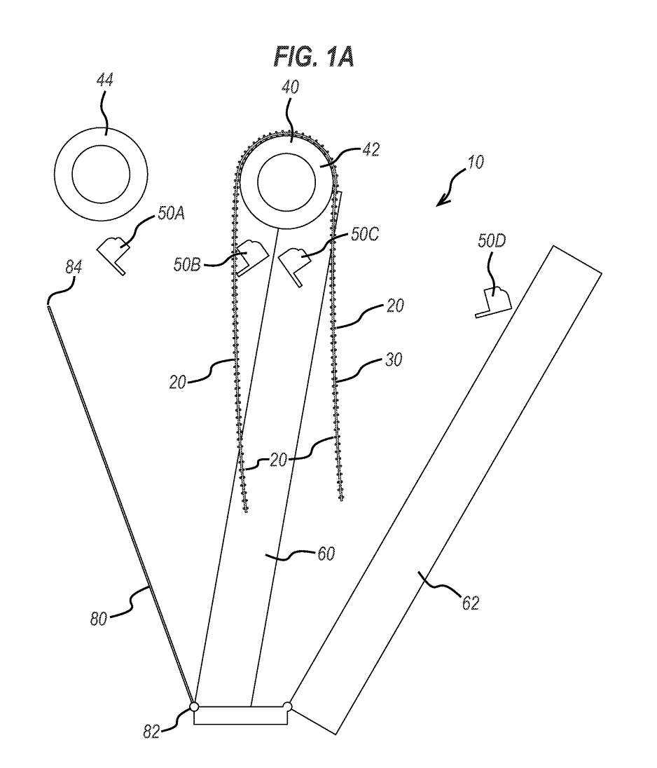

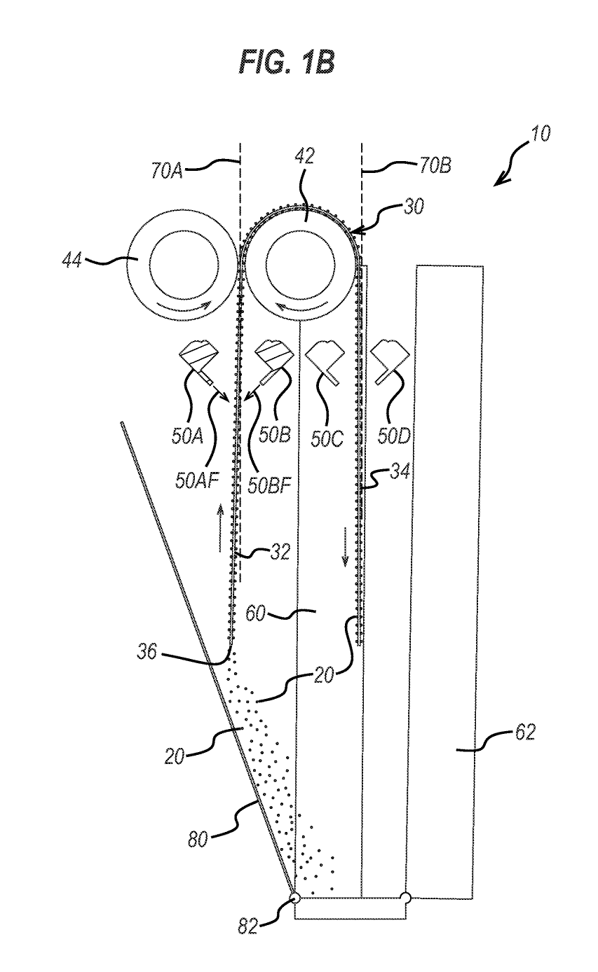

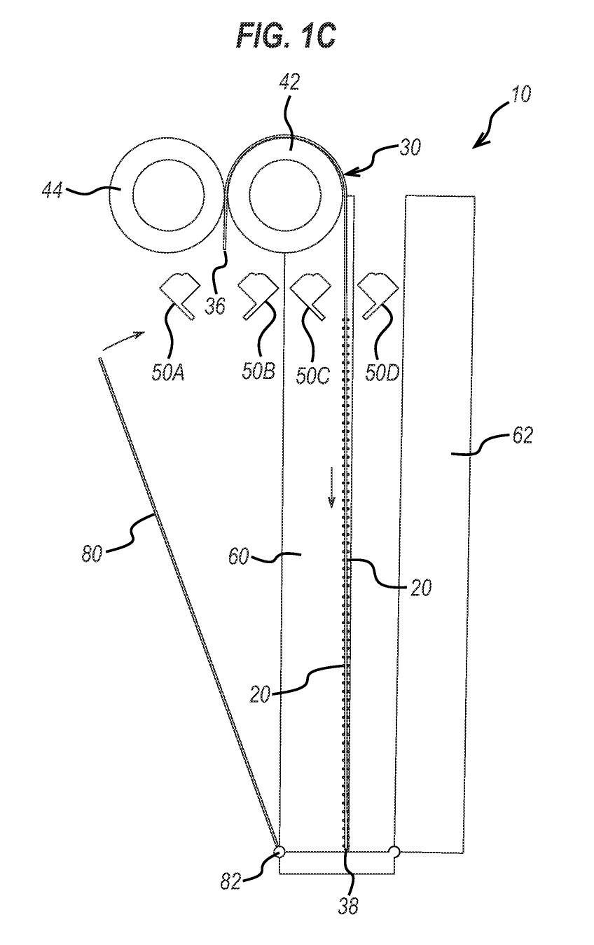

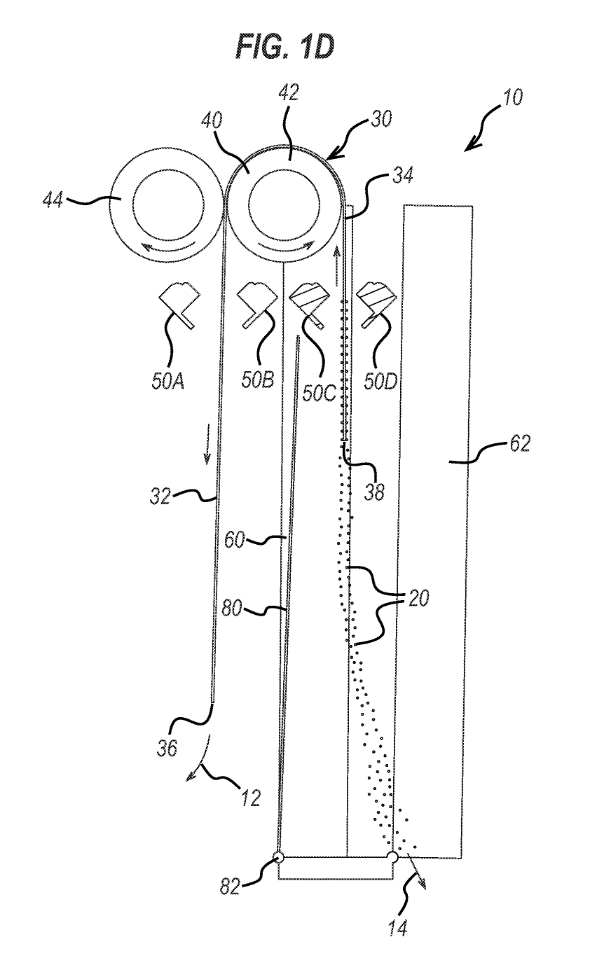

One example of a preferred construction of an apparatus according to the present invention is indicated schematically in FIG. 1.

In FIG. 1A, the apparatus 10 is shown in a preliminary configuration prior to the removal of the solid particulate material. Solid particulate material is indicated schematically by dots 20, which are not indicative of the size of the solid particulate material. The animal skin substrate 30 is shown in FIG. 1A draped over a support 40 in the form of a generally cylindrical roller 42. The support roller can be mounted on a support element 60. The roller 42 can have a smooth surface, a textured surface or can take the form of a cylindrical brush roller, as appropriate to ensure that the animal skin substrate can be properly supported thereon and such that rotation of the roller causes a corresponding movement of the animal skin substrate 30. In one preferred embodiment, the apparatus 10 can comprise a second roller 44 which is mounted to a support element (not shown) and which can be moved between a first position in which it is spaced apart form support roller 42 and a second position (FIG. 1B-1D) in which the second roller 44 is arranged in close proximity to the support roller 42. In the second position, the second roller 44 can act as a pinch roller to assist in moving the animal skin substrate on rotation of the support roller 42 and the second roller 44. In other preferred arrangements, the support element of the second roller 44 can be fixed or held stationary and the support element 60 of the support roller 42 can be moved to bring the support roller 42 into close proximity with the second roller 44.

The apparatus 10 further comprises at least one air knife 50. In the illustrated example at least four air knives are shown, arranged as a first pair of air knives 50A, 50B and a second pair of air knives 50C, 50D. Air knives 50B, 50C can conveniently be mounted to a common support element 60. Support roller 42 can also be mounted in fixed relation to the same support element 60. Support element 60 can be moveable between a relatively upright position (FIG. 1B) and a relatively inclined position (FIG. 1A). Air knife 50A can be mounted in fixed relation to the same support element as second roller 44. In this way, the air knives 50A, 50B of the first pair can be moved between relatively spaced apart positions (FIG. 1A) and relatively closer together positions (FIG. 1B). Similarly, air knife 50D can be mounted in fixed relation to a moveable support element 62. In this way, the air knives 50C, 50D of the second pair can be moved between relatively spaced apart positions (FIG. 1A) and relatively closer together positions (FIG. 1B).

In the relatively closer together positions of the air knives of the first and second pairs, in each pair the air outlet flows of the air knives are directed downwardly and towards a plane (70A, 70B respectively) extending between the air knives of each pair. Typically, the output air flows of the air knives can (in the relatively closer together position) be directed at a downward angle (to the horizontal) of about 1° to not more than 88° or even 90°, such as from about 5° to about 85°, from about 20° to about 70°, from about 30° to about 60° or from about 40° to about 50°. In some preferred embodiments the output air flows of the air knives can (in the relatively closer together position) be directed at a downward angle of about 45° to the horizontal. In some preferred embodiments the output air flows of the air knives can (in the relatively closer together position) be directed at a downward angle of about 90° or about perpendicular to the horizontal. One exemplary direction of outlet air flows for air knives 50A and 50B is indicated in FIG. 1B by arrows 50AF and 50BF respectively.

As noted above, the air output flow of the or each air knife is substantially planar.

In some preferred arrangements the plane of the output air flow is arranged substantially parallel to the axis of rotation of the support roller 42. In other preferred arrangements said plane of the out air flow can be arranged at an angle with respect to the axis of rotation of the support roller 42, for example to direct air flow of the respective air knife to a particular region of the animal skin substrate.

The apparatus 10 can further comprise at least one suction device such as a vacuum arrangement arranged adjacent to one or more of (and preferably adjacent to all of) the air knives 50A, 50B, 50C and 50D. The suction device, or respective suction inlets thereof, can conveniently be mounted to support elements 60, 62 and to the support element of second roller 44. Typically, a suction inlet or each suction inlet of the suction device can (in the relatively closer together position of the air knives) be directed at a upward and/or downward angle of about 1° to about 90°, such as from about 5° to about 85°, from about 20° to about 70°, from about such as 30° to about 60° or from about 40° to about 50° to the horizontal. In some preferred embodiments the or each inlet of the suction device (in the relatively closer together position) can be directed at an upward and/or downward angle of about 45° to the horizontal. In some preferred embodiments the or each inlet of the suction device can (in the relatively closer together position) be directed at an upward and/or downward angle of about 90° or about perpendicular to the horizontal.

The or each respective inlet of the suction device can conveniently be positioned from about 0.1 to about 50 mm from the animal skin substrate, such as from about 1 to about 25 mm, from about 2 to about 20 mm, from about 4 to about 15 mm from about 5 to about 10 mm from the surface of the animal skin substrate. The or each respective inlet of the suction device can typically be positioned from about 5 to about 10 mm from the surface of the animal skin substrate.

A collecting vessel configured to collect the solid particulate material on displacement thereof from the animal skin substrate is arranged about the animal skin substrate 30 and the air knives 50. Not all elements of the collecting vessel are shown in the Figures and it is noted that the collecting vessel could take numerous suitable forms, provided that it is configured successfully to collect the solid particulate material. In the illustrated embodiment, support element 62 can be taken as one wall of a collecting vessel and an opposed wall is indicated at 80. Wall 80 is moveable between relatively open and relatively closed positions (FIGS. 1A and 1B respectively). In the illustrated embodiments, the wall 80 pivots or hinges about a pivot 82 and as such can move about the pivot between an open position in which topmost part 84 of wall 80 is spaced relatively far apart from the support element 60 to a relatively closed position in which the topmost part 84 of wall 80 is spaced relatively close to the support element 60.

As noted above, with the apparatus in the configuration indicated in FIG. 1A, the animal skin substrate is initially draped over support roller 42 so that portions of the animal skin substrate 30 can hang in a flat and smooth configuration (as defined herein) at respective sides of the support roller 42. In the configuration illustrated in FIG. 1A, the rollers 42 and 44 are relatively spaced apart and the air knives of each pair are relatively spaced apart. Thus this configuration facilitates mounting of the animal skin substrate 30 to the apparatus 10.

After mounting of the animal skin substrate 30 to the support roller 42, the apparatus 10 is brought to the configuration shown in FIG. 1B in which the rollers 42, 44 contact respective opposed sides of the animal skin substrate 30 and the air knives 50 of the respective air knife pairs are arranged closer together with portions of the animal skin substrate passing between the air knives. In particular, in this configuration the air knives of the first pair of air knives 50A, 50B are arranged on opposed sides of a first portion 32 or the animal skin substrate 30 which drapes substantially vertically at a first lateral side of the support roller 42 and the second pair of air knives 50C, 50D arranged on opposed sides of a second portion 34 or the animal skin substrate 30 which drapes substantially vertically at a second lateral side of the support roller 42. In some situations, depending for example on the size of the animal skin substrate, it is possible that the positions of the animal skin substrate may not at all times extend between the respective pairs of air knives. However, it can be appreciated that in such cases the air knives of the respective pairs are nevertheless arranged on respective sides of the movement path of the first and second portions 32, 34 of the animal skin substrate 30 at respective sides of the support roller 42.

From the configuration shown in FIG. 1B, the rollers 42 44 are rotated to move the animal skin substrate 30. One or both of the rollers 42, 44 can be rotated by suitable drive means which can typically be an electric motor. Preferably, the rollers 42, 44 are rotated in opposite directions (one clockwise, one counter clockwise) at the same rotational speed.

Specifically, from the configuration of FIG. 1B, support roller 42 is rotated clockwise so that first portion 32 of animal skin substrate moves upwardly and consequently second portion 34 of animal skin substrate 30 moves downwardly. During such movement, first portion 32 is subjected to the action of the air knives 50A and 50B of the first pair, thereby to displace solid particulate material from the portion 32, the solid particulate material then being collected by the collecting vessel. Wall 80 serves to direct solid particulate material displaced form the portion 32 into lower parts of the collecting vessel. During such movement, second portion 34 can also subjected to the action of the air knives 50C and 50D of the second pair.

Rotation of the support roller 42 in the clockwise direction continues until the lowermost part 36 of the first portion 32 has moved upwardly to such an extent that it is no longer subject to the action of the air knives 50A, 50B. Rotation of the support roller 42 is then stopped (FIG. 10).

As indicated in FIG. 10, wall 80 is then moved to its relatively closed position, which position is shown in FIG. 1D. In adopting this position, at least an upper part of wall 80 crosses the path of downward movement of the first portion 32 of the animal skin substrate 30. Expressed differently, at least an upper part of the wall 80 moves from one side of plane 70A to the other. In the relatively closed position, on downward movement of the first portion 32 of the animal skin substrate from the position shown in FIG. 10, the first portion 32 is not captured by the collecting vessel 32 and thus remains outside the collecting vessel. This arrangement thus facilitates discharge of the animal skin substrate 30 from the apparatus 10, as indicated schematically by arrow 12.

As noted, support roller 42 is next rotated in a counter-clockwise direction. Thus, second portion 34 of animal skin substrate moves upwardly and consequently first portion 32 of animal skin substrate 30 moves downwardly (for discharge from the apparatus 10). During such movement, second portion 34 is subjected to the action of the air knives 50C and 50D of the second pair, thereby to displace solid particulate material from the second portion 34, the solid particulate material being collected by the collecting vessel. Rotation of the support roller 42 in the counter-clockwise direction continues at least until the lowermost part 38 of the second portion 34 has moved upwardly to such an extent that it is no longer subject to the action of the air knives 50C, 50D of the second pair and can continue until the animal skin substrate is discharged from the apparatus 10.

The apparatus is configured to ensure that all parts of the animal skin substrate are subjected to the action of the air knives. The particular required configuration can depend for example on the size of the typical animal skin substrate 30 which the apparatus 10 receives. Configuration can involve, for example, selection of an appropriate diameter of the support roller 42, an appropriate height for the support elements 60, 62 and/or the vertical position of the said air knives 50A, 50B, 50C and 50D relative to the said support rollers 40 and 42. In selecting the appropriate configuration it is important that the movement of the animal skin substrate by the support roller 42 is sufficient to ensure that the lowest part of the first portion 32 which is not subject to the action of the first pair of air knives 50A, 50B is, after rotation of the support roller 42, subject to the action of the second pair of air knives 50C, 50D. The lowest part of the first portion 32 which is not subject to the action of the first pair of air knives 50A, 50B can be seen as that part of the first portion which, in its initial position is immediately above the line of action of the air output flows of the air knives 50A, 50B.

The first and second portions 32, 34 of the animal skin substrate can be subjected to more than one passage between the respective pairs of air knives before the position of wall 80 is adjusted and the animal skin substrate 30 is discharged from the apparatus.

The collected solid particulate material can be discharged or otherwise emptied from the collecting vessel at a suitably convenient time, as indicated schematically by arrow 14.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of recovering a solid particulate material from an animal skin substrate subjected to a treatment using said particulate material, the method comprising supporting the animal skin substrate on a support, directing an output flow of air from at least one air knife to the animal skin substrate and moving at least one of the air knife and the animal substrate relative to the other thereby to displace solid particulate material from the animal skin substrate.

2. A method as claimed in claim 1 comprising maintaining the animal skin substrate substantially stationary and moving the, or each, air knife relative to the animal skin substrate.

3. A method as claimed in claim 1 comprising maintaining the, or each, air knife substantially stationary and moving the animal skin substrate relative to the, or each, air knife.

4. A method as claimed in any of claims 1 to 3 comprising moving relative to one another (i) the animal skin substrate and (ii) a first air knife arranged to direct its flow of air towards a first surface of the animal skin substrate and a second air knife arranged to direct its flow of air towards an opposed second surface of the animal skin substrate.

5. A method as claimed in any of claims 1 to 4 comprising supporting the animal skin substrate in a substantially horizontal attitude.

6. A method as claimed in any of claims 1 to 4 comprising supporting the animal skin substrate in a substantially vertical attitude. A method as claimed in any of claims 1 to 4 comprising supporting the animal skin substrate in an inclined attitude.

8. A method as claimed in any of claims 1 to 7 further comprising collecting solid particulate material displaced from the animal skin substrate by the or each air knife with or in a collecting device.

9. A method as claimed in claim 6 comprising mounting the animal skin substrate about a support of substantially cylindrical shape and rotating said support about its longitudinal axis thereby to move the animal skin substrate relative to the at least one air knife.

10. A method as claimed in claim 9 wherein the support is a roller or substantially cylindrical brush.

11. A method as claimed in claim 9 or 10 comprising rotating said support to pass a first portion of the animal skin substrate extending substantially vertically downwardly from the support at a first side of the support between a first pair of air knives arranged at the first side of the cylindrical support and rotating said support to pass a second portion of the animal skin substrate extending substantially vertically downwardly from the support at a second side of the support between a second pair of air knives arranged at the second side of the cylindrical support, the air flow of each air knife of the pair being directed towards a plane extending between the air knives of the pair.

12. A method as claimed in claim 11 wherein the air flow of each air knife is directed downwardly.

13. A method as claimed in claim 11 or 12 further comprising moving an upwardly arranged wall member of a collecting vessel between a first position in which the vessel is configured to collect solid particulate material being displaced from the first portion of the animal skin substrate by the air knifes, and a second position in which a substantially vertical plane extending between the air knives of the first pair is external to a solid particulate material receiving portion of the vessel, and rotating said support to move said first portion downwardly in said plane.

14. A method as claimed in claim 11 or 12 comprising arranging the animal skin substrate on the support such that a first lower marginal portion of the animal skin substrate at a the first side of the support is disposed below the first pair of air knives, arranging a collecting vessel to collect solid particulate material displaced from said first and second portions of the animal skin substrate, rotating the support such that said first lower marginal portion moves upwardly and said first portion of the animal skin substrate passes between the air output flows of the first pair of air knives and said second portion of the animal skin substrate moves downwardly between the second pair of air knives, adjusting a collecting vessel to a second position or configuration, rotating the support such that said first lower marginal portion moves downwardly and said second portion of the animal skin substrate moves upwardly between the second pair of air knives, wherein (a) the second position or configuration of the collecting vessel is such that, by said downward movement of the first lower marginal portion, at least the first marginal portion of the animal skin substrate is positioned externally of the collecting vessel (b) the extent of rotation of the support is such that every part of the animal skin substrate is subjected to air output flows of the first or second pair of air knives.

15. A method of treating an animal skin substrate comprising agitating said animal substrate in a vessel in the presence of solid particulate material and treatment chemicals, removing the animal substrate from the vessel and recovering said solid particulate material by a method according to any of claims 1 to 14.

16. A method as claimed in claim 15 further comprising re-using the recovered solid particulate material in a further method according to claim 15.

17. A method according to claim 15 or 16 wherein the vessel is a rotatably mounted drum and the agitation of the animal skin substrate comprises rotating the drum.

18. A method as claimed in any of claims 1 to 17 wherein said solid particles have an average particle diameter of from 1 mm to 100 mm.

19. A method as claimed in any of claims 1 to 17 wherein said solid particles have a length of from 1 mm to 100 mm.

20. A method as claimed in any of claims 1 to 19 wherein the solid particles comprise a multiplicity of polymeric particles, a multiplicity of non-polymeric particles, or a mixture of a multiplicity of polymeric and non-polymeric particles.

21. Apparatus for recovery of a solid particulate material from an animal skin substrate subjected to a treatment using said particulate material, the apparatus comprising a support arranged to support the animal skin substrate, at least one air knife arranged to direct its output flow of air to the animal skin substrate when supported on the support, and a transport arrangement configured to move at least one of the air knife and the animal substrate relative to the other.

22. Apparatus as claimed in claim 21 wherein the animal skin substrate is maintained stationary and the transport arrangement is operable to move the, or each, air knife relative to the animal skin substrate.

23. Apparatus as claimed in claim 21 wherein the, or each, air knife is maintained stationary and the transport arrangement is operable to move the animal skin substrate relative to the, or each, air knife.

24. Apparatus as claimed in claim 23 wherein the transport arrangement is the support or a part or component thereof.

25. Apparatus as claimed in any of claims 21 to 24 comprising a first air knife arranged to direct its flow of air towards a first surface of the animal skin substrate and a second air knife arranged to direct its flow of air towards an opposed second surface of the animal skin substrate.

26. Apparatus as claimed in any of claims 21 to 25 wherein the support supports the animal skin substrate in a substantially horizontal attitude.

27. Apparatus as claimed in any of claims 21 to 25 wherein the support supports the animal skin substrate in a substantially vertical attitude.

28. Apparatus as claimed in any of claims 21 to 25 wherein the support supports the animal skin substrate in an inclined attitude.

29. Apparatus as claimed in any preceding claim further comprising a collecting device arranged to collect the solid particulate material displaced from the animal skin substrate by the or each air knife.

30. Apparatus as claimed in claim 27 wherein the support is of substantially cylindrical shape and configured for rotation about its longitudinal axis thereby to move the animal skin substrate relative to the at least one air knife.

31. Apparatus as claimed in claim 30 wherein the support is a roller or substantially cylindrical brush.

32. Apparatus as claimed in claim 30 or 31 comprising first and second pairs of air knives arranged at respective sides of the cylindrical support, each air knife pair being arranged so that the air outlets thereof are substantially parallel to the longitudinal axis of the cylindrical support and the air output flow of each air knife of the pair being directed towards a plane extending between the air knives of the pair, the air knives being so positioned or positionable that a portion of the animal skin substrate extending substantially vertically downwardly from the support at a first side of the support can pass between the air knives of the first pair and a portion of the animal skin substrate extending substantially vertically downwardly from the support at a second side of the support can pass between the air knives of the second pair.

33. Apparatus as claimed in claim 32 wherein the air output flow of each air knife is directed downwardly.

34. Apparatus as claimed in claim 32 or 33 further comprising a collecting vessel configured to collect solid particulate material displaced from the animal skin substrate by the air knives, the vessel including an upwardly arranged wall member moveable between a first condition in which the plane extending between the first pair of air knives extends within a solid particulate material receiving portion of the vessel and a second condition in which said plane is external to a solid particulate material receiving portion of the vessel.

35. Apparatus as claimed in any of claims 21 to 34 wherein said solid particles have an average particle diameter of from 1 mm to 100 mm.

36. Apparatus as claimed in any of claims 21 to 35 wherein said solid particles have a length of from 1 mm to 100 mm.

37. Apparatus as claimed in any of claims 21 to 36 wherein the solid particles comprise a multiplicity of polymeric particles, a multiplicity of non-polymeric particles, or a mixture of a multiplicity of polymeric and non-polymeric particles.
